(19) United States
(12) Patent Application Publication
(10) Pub. No.: US 2014/0219549 A1
(43) Pub. Date: Aug. 7, 2014

(54) METHOD AND APPARATUS FOR ACTIVE STEREO MATCHING

(71) Applicant: Electronics and Telecommunications Research Institute, Daejeon (KR)

(72) Inventors: Seung Min CHOI, Daejeon (KR); Dae Hwan HWANG, Daejeon (KR); Eul Gyoon LIM, Daejeon (KR); HoChul SHIN, Daejeon (KR); Jae-Chan JEONG, Daejeon (KR); Jae IL CHO, Daejeon (KR); Kwang Ho YANG, Daejeon (KR); Jiho CHANG, Daejeon (KR)

(73) Assignee: Electronics and Telecommunications Research Institute, Daejeon (KR)

(21) Appl. No.: 14/021,956

(22) Filed: Sep. 9, 2013

(30) Foreign Application Priority Data
Feb. 1, 2013 (KR) 10-2013-0011923

(51) Int. Cl. G06T 7/00

(52) U.S. Cl. CPC G06T 7/0075
USPC 382/154

(57) ABSTRACT

An active stereo matching method includes extracting a pattern from a stereo image, generating a depth map through a stereo matching using the extracted pattern, calculating an aggregated cost for a corresponding disparity using a window kernel generated using the extracted pattern and a cost volume generated for the stereo image, and generating a disparity map using the depth map and the aggregated cost.

### RELATED APPLICATIONS(S)

This application claims the benefit of Korean Patent Application No. 10-2013-0011923, filed on Feb. 1, 2013, which is hereby incorporated by references as if fully set forth herein.

### FIELD OF THE INVENTION

The present invention relates to an active stereo matching scheme, and more particularly, to a method and apparatus for an active stereo matching, which is suitable indoors and outdoors by using an active light source among stereo matching technologies for calculating a 3-dimensional space information map, and specially by integrating the active light source into an existing stereo matching technology.

### BACKGROUND OF THE INVENTION

Recently, researches, which try to utilize a gesture of a person as an input device, such as a keyboard, a remote controller, and a mouse, by detecting the gesture (movement) of the person using 3-dimensional information and using gesture detection information as a control instruction for an apparatus, are proceeding actively.

For example, technologies for various input devices utilizing a gesture of a person are developed and being used in real life. The input device includes a gesture recognition device such as a gesture recognition device using an adhension-type haptic device (Nintendo Wii), a gesture recognition device using a tactile touch screen (Capacitive Touch Screen of Apple IPAD), or a short-distance (in several meters) contactless gesture recognition device (Kinect device of MS XBOX).

Among the above gesture recognition technologies, an example of applying a 3D scanning scheme utilizing high precision machine vision, which has been used for army or factory automation, to a general application is the Kinect device of Microsoft Corporation. The Kinect device is a real-time 3D scanner for projecting a laser pattern of a Classl grade into a real environment, detecting a disparity map by distance occurring between a projector and a camera, and converting the detected disparity map into 3D frame information. The Kinect device is a device commercialized by Microsoft Corporation based on a technology of PrimeSense in Israel.

The Kinect device is one of the best sellers among 3D scanners that a user has been used without problems in the safety. A 3D scanner having a similar type to that of the Kinect device and derivatives utilizing it are being developed actively.

FIG. 1 is a conceptual view for explaining a Kinect scheme to which a structured light system is applied. FIG. 2 is a conceptual view for explaining an active stereo vision scheme.

FIG. 1 shows a structured light scheme requiring one projection device and one camera. FIG. 2 shows an active stereo vision scheme using one projection device and a stereo camera.

First of all, referring to FIG. 1, the conventional scheme for acquiring 3D information using vision includes (1-1) generating a reference pattern and storing it, (1-2) projecting the reference pattern onto a subject through a projector or a diffuser, (1-3) photographing the subject, which is at a projected location, at a baseline that is in a certain distance from the projector, (1-4) extracting the pattern from the photographed image, and (1-5) matching the extracted pattern with the reference pattern to calculate a disparity occurring by the certain distance and converting the disparity into 3D information.

Referring to FIG. 2, the active stereo vision scheme is similar to the structured light scheme of FIG. 1. However, the active stereo vision scheme is different from the structured light scheme since it includes components required for a passive stereo vision technology in steps (2-3), (2-4), and (2-5). In particular, a pattern matching step (2-5) can be implemented with various combinations such as comparison between stereo images or comparison between a reference pattern and a photographed stereo vision.

However, the structured light scheme of FIG. 1 has a problem that it is difficult to extract a precise depth map in calculating 3D information. The active stereo scheme of FIG. 2 has a problem that it is difficult to be used outdoors.

FIG. 3 is a flowchart showing a procedure of performing a stereo matching in a conventional stereo vision system.

Referring to FIG. 3, if a stereo image is input from a camera (not shown), preprocessing such as noise removal and image rectification is performed on the stereo image at step 302, and a cost volume is generated by calculating a raw cost from the preprocessed image at step 304.

After that, a window kernel is generated to secure dis-similarity between right and left images at step 306. The dis-similarity has a higher value when a content of an object is much different. At step 308, an aggregated cost for a corresponding disparity is calculated using the window kernel and the cost volume.

Subsequently, a disparity map is generated using the aggregated cost and a depth map at step 310. Finally, the matching of the active stereo vision scheme is completed by rectifying the disparity map in a manner of comparing each disparity in the disparity map and its previous disparity at step 312.

The conventional active stereo vision scheme can be implemented with a general active stereo vision scheme to which pattern projection utilizing a light source is added. As an example, this implementation can be predicted through active stereo vision results shown in FIGS. 4a and 4b.

FIG. 4a illustrates a screen showing an input image, which includes a pattern, in a conventional active stereo vision scheme. FIG. 4b illustrates a screen showing a disparity map obtained through the conventional active stereo vision scheme.

However, in case of the typical active stereo vision scheme, as can be seen from FIGS. 4a and 4b, a pattern, which is in a form of a large number of small random dots, exists in the disparity map. As a result, since the performance of the stereo vision may be deteriorated, it is difficult to expect that the performance of the depth map is substantially enhanced.

### SUMMARY OF THE INVENTION

As well known, a 3-dimensional extraction method of a structured light scheme including an active light source has limitations in optical, physical, and power consumptive viewpoints when increasing the brightness of a pattern projected by the active light source and the density thereof.

In general, as the density of a structured light pattern, i.e., an extent of fineness between patterns, becomes higher, it is possible to calculate a precise depth map. However, since there is a process limitation in manufacturing a structured light pattern having increased density, it may be difficult to calculate a depth of a small or thin object even in a short distance.

For instance, even if Kinect, which is being sold by Microsoft Corporation, is used, it is difficult to calculate a depth of a finger or wooden chopsticks in a 3-meter distance. Even from a distance longer than 1.5 meters, it is difficult to accurately calculate a depth of a finger. This is because the density of a pattern formed at a boundary between a finger and a side above the finger is low even though the finger is photographed by an infrared (IR) camera of Kinect.

Therefore, there is a limitation depending on a distance when using a conventional structured light technology in an application that is based on the elaborate 3D finger detection. To overcome the drawbacks, the present invention provides a method of projecting an active pattern into the conventional stereo matching scheme for hybridization.

In accordance with an aspect of the present invention, there is provided an active stereo matching method including: extracting a pattern from a stereo image; generating a depth map through a stereo matching using the extracted pattern; calculating an aggregated cost for a corresponding disparity using a window kernel generated using the extracted pattern and a cost volume generated for the stereo image; and generating a disparity map using the depth map and the aggregated cost.

The method may further include rectifying the disparity map by comparing each disparity in the disparity map and a corresponding previous disparity.

The window kernel may be generated by comparing left and right images in the stereo image using a block matching algorithm.

The cost volume may be generated by calculating a raw cost that is possible up to a maximum disparity with respect to a reference image.

The raw cost may be calculated using an absolute difference scheme.

In accordance with another aspect of the present invention, there is provided an active stereo matching method including: extracting a pattern from an input stereo image; generating a depth map of ground truth by performing a stereo matching using the pattern; restoring a pattern location in the input stereo image using pixels around the pattern; generating a window kernel to secure dis-similarity of left and right images from the restored image; generating a cost volume by calculating a raw cost from the input stereo image; calculating an aggregated cost for a corresponding disparity using the window kernel and the cost volume; generating a disparity map using the aggregated cost and the depth map; and rectifying the disparity map by comparing each disparity in the disparity map and a corresponding previous disparity.

Generating the window kernel may include comparing the left and right images using a block matching algorithm.

Generating the cost volume may include calculating the raw cost that is possible up to a maximum disparity with respect to a reference image.

The raw cost may be calculated using an absolute difference scheme.

Calculating the aggregated cost may include securing a vector product of the cost volume and the window kernel and calculating a central point of a window as the aggregated cost for the corresponding disparity.

Generating the disparity map may include storing a disparity causing a lowest cost among aggregated costs as a disparity of the central point of the window. The lowest cost may be searched through a local matching or global matching scheme.

Rectifying the disparity map may include comparing a disparity obtained by exchanging a reference disparity and a target disparity with a corresponding previous disparity.

Rectifying the disparity map may be performed using any of a left/right consistency checking scheme, an occlusion detecting and filling scheme, and a sub-sampling scheme.

In accordance with still another aspect of the present invention, there is provided an active stereo matching apparatus including: a pattern extraction block configured to extract a pattern from an input stereo image; a pattern matching block configured to generate a depth map of ground truth by performing a stereo matching using the pattern; an image restoration block configured to restore a pattern location in the input stereo image using pixels around the pattern; a window kernel generation block configured to generate a window kernel to secure dis-similarity of left and right images from the restored image; a cost calculation block configured to generate a cost volume by calculating a raw cost from the input stereo image; an aggregated cost calculating block configured to calculate an aggregated cost for a corresponding disparity using the window kernel and the cost volume; and a stereo matching block configured to generate a disparity map using the aggregated cost and the depth map.

The window kernel generation block may be configured to generate the window kernel by comparing the left and right images using a block matching algorithm.

The raw cost calculation block may be configured to calculate the raw cost that is possible up to a maximum disparity with respect to a reference image using an absolute difference scheme.

The aggregated cost calculation block may be configured to secure a vector product of the cost volume and the window kernel and calculate a central point of a window as the aggregated cost for the corresponding disparity.

The stereo matching block may be configured to generate a disparity causing a lowest cost among aggregated costs as a disparity of a central point of a window.

The stereo matching block may be configured to search the lowest cost through a local matching or global matching scheme.

In accordance with the embodiments of the present invention, by introducing a scheme of projecting an active pattern into the conventional stereo matching scheme and hybridizing the schemes, it is possible to solve a problem that a precise depth map cannot be extracted in the conventional structured light scheme. In addition, unlike the conventional active stereo scheme that may not be used outdoors, it is possible to effectively implement the indoor and outdoor use.

### BRIEF DESCRIPTION OF THE DRAWINGS

The above and other objects and features of the present invention will become apparent from the following description of embodiments given in conjunction with the accompanying drawings, in which:

FIG. 1 is a conceptual view for explaining a Kinect scheme to which a structured light system is applied;

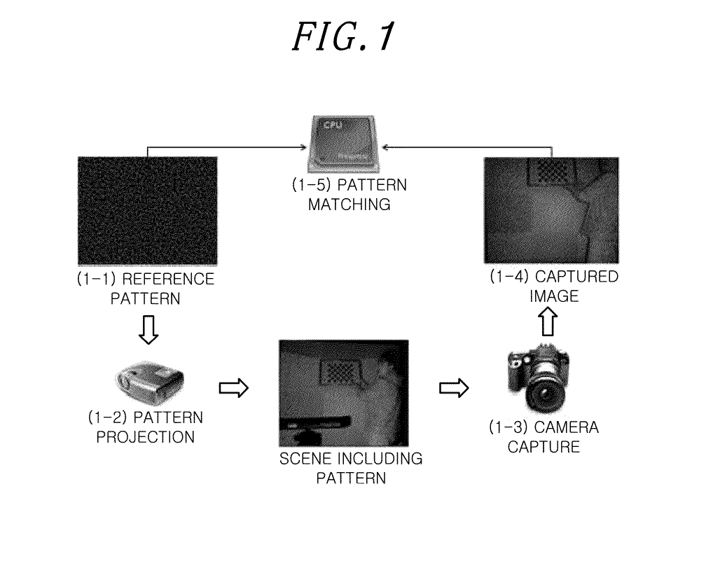

FIG. 2 is a conceptual view for explaining an active stereo vision scheme;

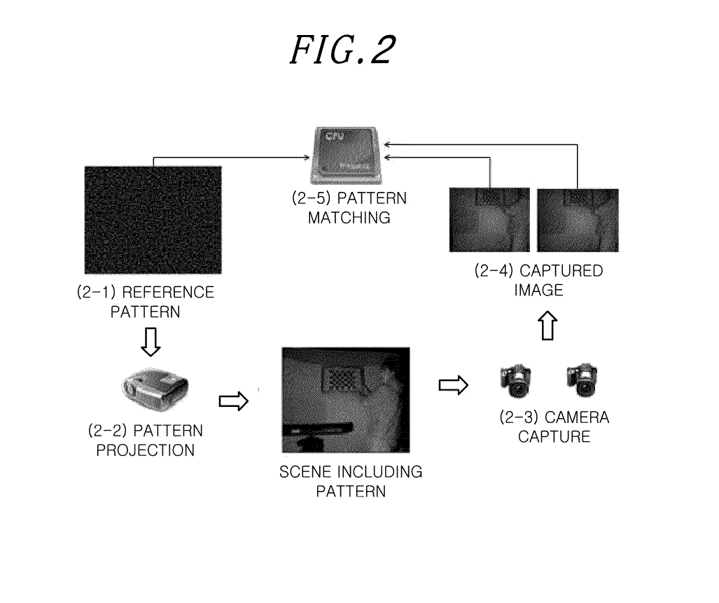

FIG. 3 is a flowchart showing a procedure of performing a stereo matching in a conventional stereo vision system;

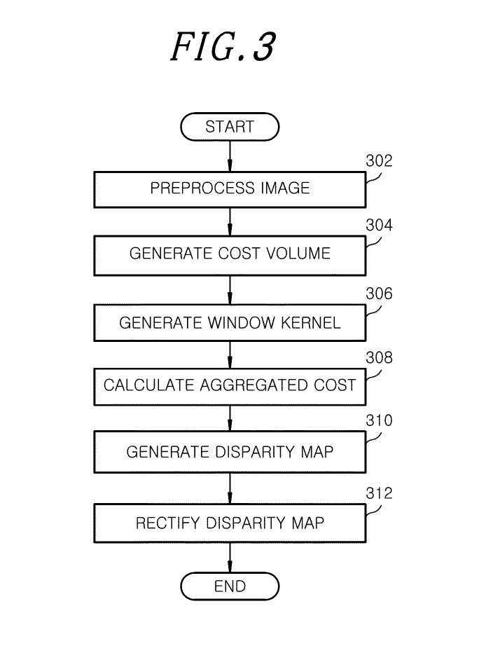

FIG. 4a illustrates a screen showing an input image, which includes a pattern, in a conventional active stereo vision scheme;

FIG. 4b illustrates a screen showing a disparity map obtained through the conventional active stereo vision scheme;

FIG. 5 illustrates a block diagram of an active stereo matching apparatus in accordance with an embodiment of the present invention;

FIG. 6 is a flowchart showing a procedure of performing an active stereo matching on a stereo image input from a stereo camera in accordance with an embodiment of the present invention;

FIG. 7a illustrates a screen of an image provided to a raw cost calculation block in accordance with an embodiment of the present invention;

FIG. 7b illustrates a screen of an image provided to a window kernel generation block in accordance with an embodiment of the present invention; and

FIG. 7c illustrates a screen showing a disparity map generated by a stereo matching block in accordance with an embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Hereinafter, embodiments of the present invention will be described in detail with reference to the accompanying drawings so that they can be readily implemented by those skilled in the art.

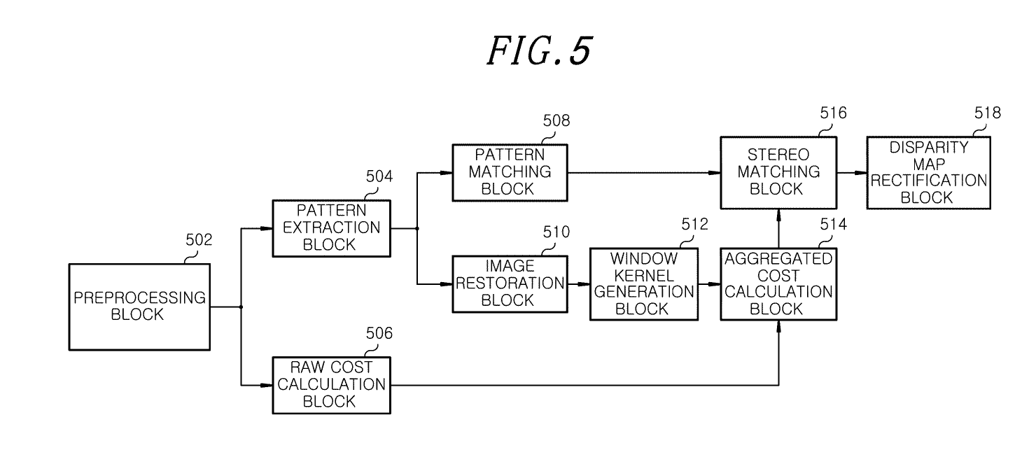

FIG. 5 illustrates a block diagram of an active stereo matching apparatus in accordance with an embodiment of the present invention, which includes a preprocessing block 502, a pattern extraction block 504, a raw cost calculation block 506, a pattern matching block 508, an image restoration block 510, a window kernel generation block 512, an aggregated cost calculation block 514, a stereo matching block 516, and a disparity map rectification block 518.

First, in order to increase a degree of precision of a disparity map unless a pattern of an original image is not shown in the disparity map, it is required to utilize both of the pattern and an object. For this purpose, in accordance with an embodiment of the present invention, left/right stereo cameras (not shown) and a projector (not shown) are used to obtain a stereo image including the pattern.

Referring to FIG. 5, the preprocessing block 502 preprocesses the stereo image including the pattern provided from the projector and the left/right stereo cameras. The preprocessed stereo image is transferred to the pattern extraction block 504 and the raw cost calculation block 506.

Herein, the preprocessing may include the noise removal and image rectification on the stereo image. The image rectification may include tuning an epipolar line and the brightness between left and right images within the stereo image.

The pattern extraction block 504 extracts or separates the pattern from the preprocessed image and transfers the extracted pattern to the pattern matching block 508 and the image restoration block 510.

The raw cost calculation block 506 calculates a raw cost from the preprocessed image. That is, the raw cost calculation block 506 calculates the raw cost, which is possible up to a maximum disparity with respect to a reference image, using an absolute difference scheme to thereby generate a cost volume. The cost volume is transferred to the aggregated cost calculation block 514. By calculating the raw cost as described above, W*H*D numbers of cost volumes are generated when the maximum disparity in a W*H image is D.

The pattern matching block 508 performs a pattern matching using the pattern extracted by the pattern extraction block 504 and generates a depth map of ground truth. The depth map is transferred to the stereo matching block 516.

The image restoration block 510 restores a pattern location in the original image from which the pattern is separated using pixels around the pattern, and transfers the restored image to the window kernel generation block 512.

The window kernel generation block 512 generates a window kernel to secure dis-similarity of the left and right images from the restored image, and transfers the window kernel to the aggregated cost calculation block 514. As much as the content of the object is different, the dis-similarity has a higher value.

Herein, the generation of the window kernel is performed by comparing the left and right images using, e.g., a block matching algorithm. To achieve more excellent performance, various window kernel calculation schemes, such as Adaptive Support Weight, Guided Filter, and Geodesic, can be used. At this time, when the window kernel has a shape reflecting a shape of an object as much as possible instead of a window shape in a rectangular form, the probability of achieving good performance becomes higher. The object is located at a center of a window, i.e., a window center.

The aggregated cost calculation block 514 calculates an aggregated cost for a corresponding disparity using the cost volume calculated by the raw cost calculation block 506 and the window kernel generated by the window kernel generation block 512, and transfers the aggregated cost to the stereo matching block 516. Herein, the aggregated cost may be calculated through a scheme of securing a vector product of the cost volume and the window kernel and calculating the window center as the aggregated cost for the corresponding disparity.

The stereo matching block 516 generates the disparity map using the aggregated cost from the aggregated cost calculation block 514 and the depth map from the pattern matching block 508, and transfers the disparity map to the disparity map rectification block 518.

Herein, the disparity map may be generated using a scheme of storing a disparity causing the lowest cost among the aggregated costs as a disparity of the window center. A method of searching the lowest cost may be performed through a local matching and/or a global matching. It is preferable to selectively apply the local matching and the global matching according to a situation to which the method is applied.

The disparity map rectification block 518 compares each disparity in the disparity map, e.g., a disparity obtained by exchanging a reference disparity and a target disparity, and its corresponding previous disparity to thereby rectify the disparity map.

Herein, the rectification of the disparity map may be performed using one of a left/right consistency checking scheme, an occlusion detecting and filling scheme, and a sub-sampling scheme. This rectification is used to enhance the reliability of the disparity map.

Hereinafter, a procedure of performing an active stereo matching on a stereo image input through left/right stereo cameras and a projector will be described using the inventive stereo matching apparatus having the configuration shown in FIG. 5.

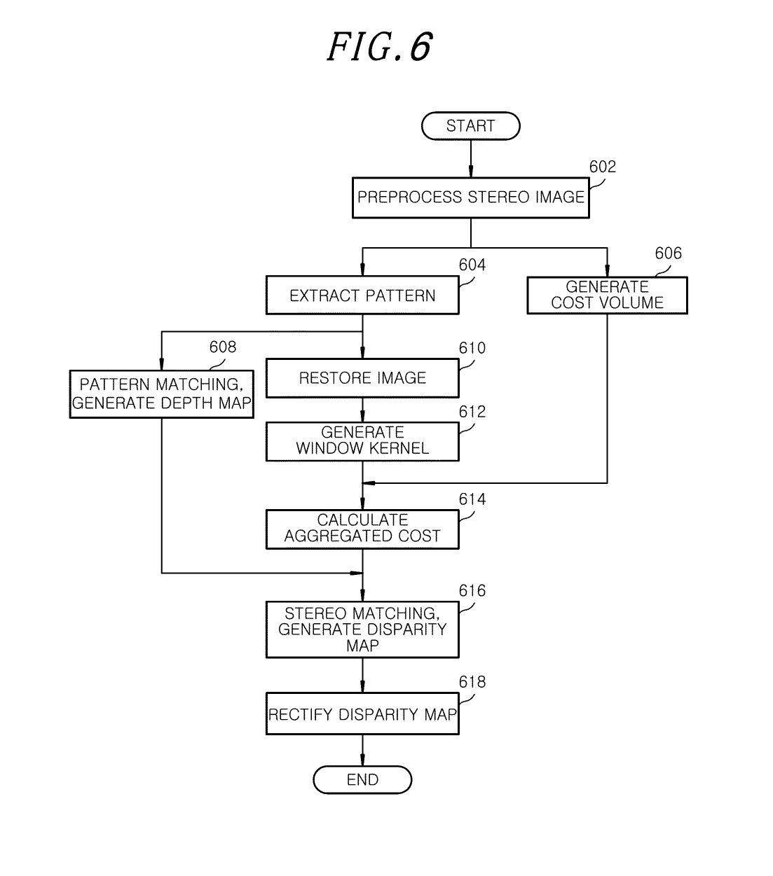

FIG. 6 is a flowchart showing a procedure of performing an active stereo matching on a stereo image input from a stereo camera in accordance with an embodiment of the present invention.

Referring to FIG. 6, if a stereo image including a pattern is input from left/right stereo cameras (not shown) and a projector (not shown), the preprocessing block 502 performs preprocessing, such as noise removal and image rectification, on the stereo image at step 602. A result of the preprocessing, i.e., the preprocessed stereo image, is transferred to the pattern extraction block 504 and the raw cost calculation block 506.

After that, the pattern extraction block 504 extracts or separates the pattern from the preprocessed stereo image and transfers the extracted pattern to the pattern matching block 508 and the image restoration block 510 at step 604. The raw cost calculation block 506 calculates a raw cost, which is possible up to the maximum disparity with respect to a reference image, using an absolute difference scheme to thereby generate a cost volume at step 606.

The pattern matching block 508 performs a pattern matching using the extracted pattern and generates a depth map of ground truth at step 608. The depth map is transferred to the stereo matching block 516.

At the same time, the image restoration block 510 restores a pattern location in the original stereo image from which the pattern is extracted using pixels around the pattern at step 610. The restored image is transferred to the window kernel generation block 512.

The window kernel generation block 512 generates a window kernel to secure dis-similarity of left and right images from the restored image, and transfers the window kernel to the aggregated cost calculation block 514 at step 612. Herein, the window kernel may be generated by comparing the left and right images using, e.g., a block matching algorithm. To achieve more excellent performance, various window kernel calculation schemes such as Adaptive Support Weight, Guided Filter, and Geodesic can be used.

Then, the aggregated cost calculation block 514 calculates an aggregated cost for a corresponding disparity using the cost volume from the raw cost calculation block 506 and the window kernel from the window kernel generation block 512 at step 614. Herein, the aggregated cost may be calculated through a scheme of securing a vector product of the cost volume and the window kernel and calculating a central point of a window as the aggregated cost for the corresponding disparity.

At step 616, the stereo matching block 516 generates a disparity map using the aggregated cost and the depth map, and transfers the disparity map to the disparity map rectification block 518. Herein, the disparity map may be generated using a scheme of storing a disparity causing the lowest cost among the aggregated costs as a disparity of the central point of the window. A method of searching the lowest cost may be performed through a local matching and/or a global matching.

The disparity map rectification block 518 rectifies the disparity map through a scheme of comparing each disparity in the disparity map, e.g., a disparity obtained by exchanging a reference disparity and a target disparity, and its corresponding previous disparity at step 618.

Herein, the disparity map may be rectified using one of a left/right consistency checking scheme, an occlusion detecting and filling scheme, and a sub-sampling scheme.

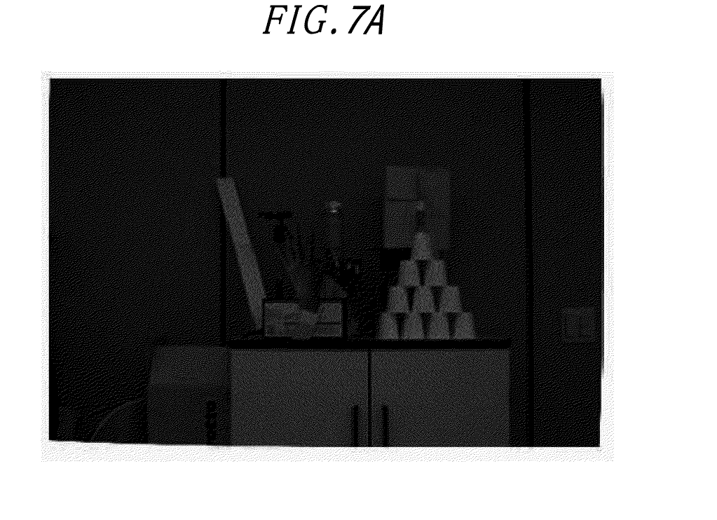

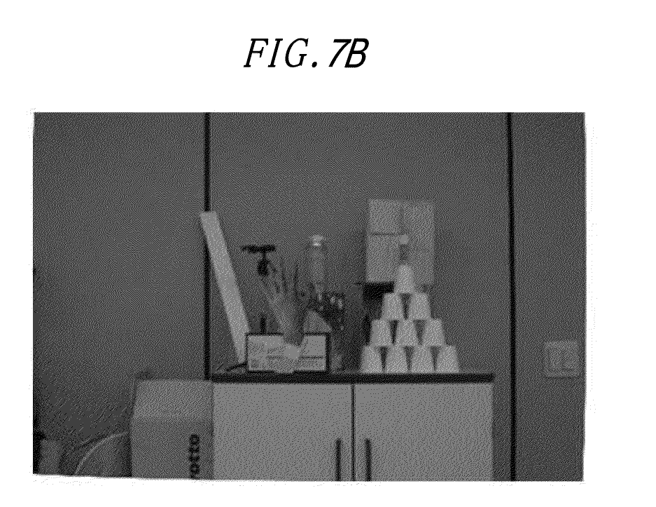

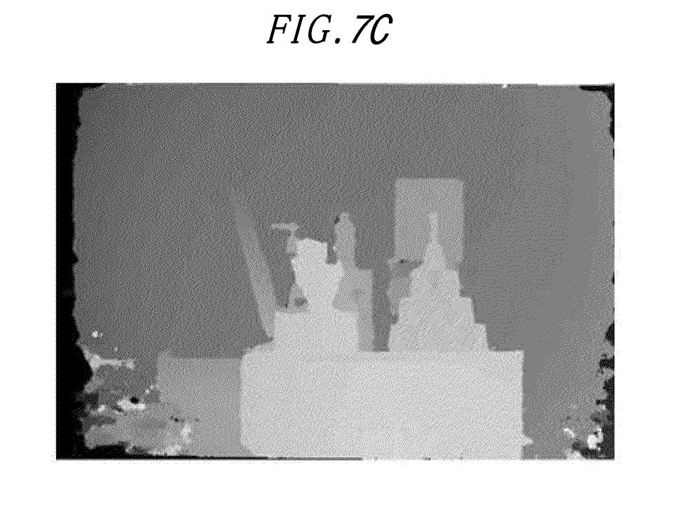

FIGS. 7a to 7c are views for explaining a procedure of performing an active stereo matching in accordance with an embodiment of the present invention. FIG. 7a illustrates a screen of an image provided to the raw cost calculation block 506 in accordance with an embodiment of the present invention. FIG. 7b illustrates a screen of an image provided to the window kernel generation block 512 in accordance with an embodiment of the present invention. FIG. 7c illustrates a screen showing the disparity map generated by the stereo matching block 516 in accordance with an embodiment of the present invention.

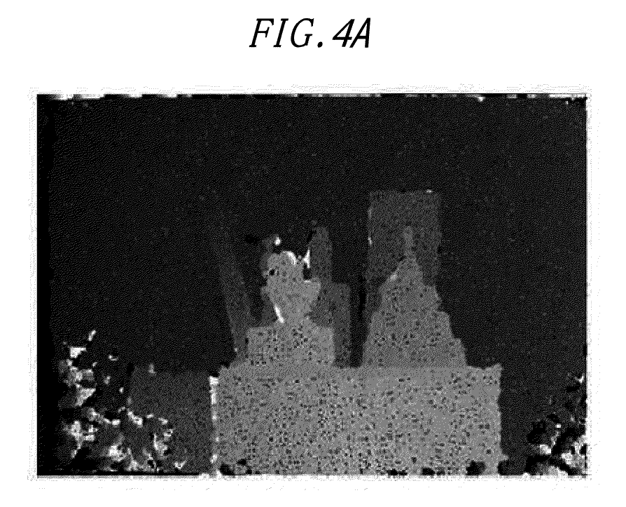

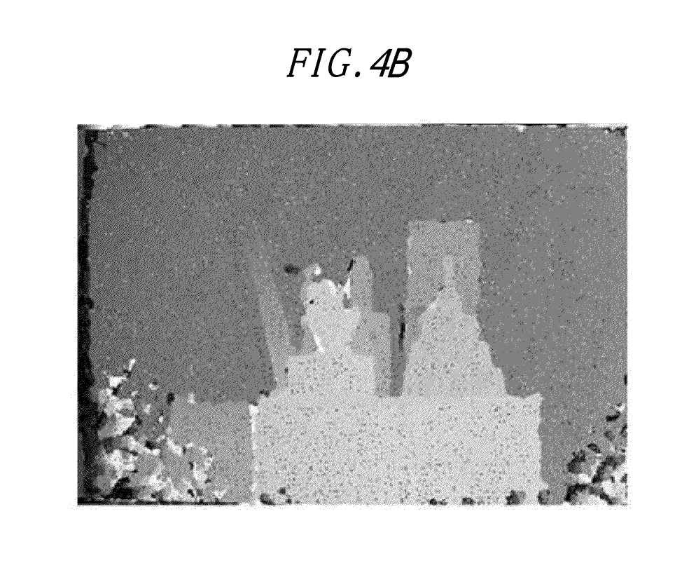

Unlike in FIG. 4b showing a conventional result, FIG. 7c clearly shows that the existence of the pattern is not shown in the disparity map generated according to the present invention and that a boundary of objects is precisely calculated.

Moreover, when it is performed outdoors, if an effect of a natural light is stronger than a pattern, the conventional structured light method cannot recognize the pattern. However, in accordance with the embodiments of the present invention, since an input of the pattern extraction block is identical to an input of the window kernel generation block, the conventional active stereo vision scheme can be activated, and thus the disparity map is normally outputted.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An active stereo matching method, comprising:
extracting a pattern from a stereo image;
generating a depth map through a stereo matching using the extracted pattern;
calculating an aggregated cost for a corresponding disparity using a window kernel generated using the extracted pattern and a cost volume generated for the stereo image; and
generating a disparity map using the depth map and the aggregated cost.

2. The method of claim 1, further comprising:
rectifying the disparity map by comparing each disparity in the disparity map and a corresponding previous disparity.

3. The method of claim 1, wherein the window kernel is generated by comparing left and right images in the stereo image using a block matching algorithm.

4. The method of claim 1, wherein the cost volume is generated by calculating a raw cost that is possible up to a maximum disparity with respect to a reference image.

5. The method of claim 4, wherein the raw cost is calculated using an absolute difference scheme.

6. An active stereo matching method, comprising:
extracting a pattern from an input stereo image;
generating a depth map of ground truth by performing a stereo matching using the pattern;
restoring a pattern location in the input stereo image using pixels around the pattern;
generating a window kernel to secure dis-similarity of left and right images from the restored image;
generating a cost volume by calculating a raw cost from the input stereo image;
calculating an aggregated cost for a corresponding disparity using the window kernel and the cost volume;
generating a disparity map using the aggregated cost and the depth map; and
rectifying the disparity map by comparing each disparity in the disparity map and a corresponding previous disparity.

7. The method of claim 6, wherein generating the window kernel comprises comparing the left and right images using a block matching algorithm.

8. The method of claim 6, wherein generating the cost volume comprises calculating the raw cost that is possible up to a maximum disparity with respect to a reference image.

9. The method of claim 8, wherein the raw cost is calculated using an absolute difference scheme.

10. The method of claim 6, wherein calculating the aggregated cost comprises:
securing a vector product of the cost volume and the window kernel; and
calculating a central point of a window as the aggregated cost for the corresponding disparity.

11. The method of claim 6, wherein generating the disparity map comprises storing a disparity causing a lowest cost among aggregated costs as a disparity of the central point of the window.

12. The method of claim 11, wherein the lowest cost is searched through a local matching or global matching scheme.

13. The method of claim 6, wherein rectifying the disparity map comprises comparing a disparity obtained by exchanging a reference disparity and a target disparity with a corresponding previous disparity.

14. The method of claim 13, wherein rectifying the disparity map is performed using any of a left/right consistency checking scheme, an occlusion detecting and filling scheme, and a sub-sampling scheme.

15. An active stereo matching apparatus, comprising:
a pattern extraction block configured to extract a pattern from an input stereo image;
a pattern matching block configured to generate a depth map of ground truth by performing a stereo matching using the pattern;
an image restoration block configured to restore a pattern location in the input stereo image using pixels around the pattern;
a window kernel generation block configured to generate a window kernel to secure dis-similarity of left and right images from the restored image;
a cost calculation block configured to generate a cost volume by calculating a raw cost from the input stereo image;
an aggregated cost calculating block configured to calculate an aggregated cost for a corresponding disparity using the window kernel and the cost volume; and
a stereo matching block configured to generate a disparity map using the aggregated cost and the depth map.

16. The apparatus of claim 15, wherein the window kernel generation block is configured to generate the window kernel by comparing the left and right images using a block matching algorithm.

17. The apparatus of claim 15, wherein the raw cost calculation block is configured to calculate the raw cost that is possible up to a maximum disparity with respect to a reference image using an absolute difference scheme.

18. The apparatus of claim 15, wherein the aggregated cost calculation block is configured to secure a vector product of the cost volume and the window kernel and calculate a central point of a window as the aggregated cost for the corresponding disparity.

19. The apparatus of claim 15, wherein the stereo matching block is configured to generate a disparity causing a lowest cost among aggregated costs as a disparity of a central point of a window.

20. The apparatus of claim 19, wherein the stereo matching block is configured to search the lowest cost through a local matching or global matching scheme.
